(19) United States
(12) Patent Application Publication
(10) Pub. No.: US 2010/0117868 A1
(43) Pub. Date: May 13, 2010

(54) SYSTEM AND METHOD FOR STORING LOCATION INFORMATION ABOUT A VEHICLE ON A WIRELESS DEVICE

(75) Inventors: John Robert Van Wiemeersch, Novi, MI (US); Steven Yellin Schondorf, Dearborn, MI (US); Fahd Ahmed, Dearborn Heights, MI (US); Amy Garby, Canton, MI (US); Jennifer L. Mezigian, Northville, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/269,362

(22) Filed: Nov. 12, 2008

(51) Int. Cl. G08G 1/123

(52) U.S. Cl. 340/989

(57) ABSTRACT

A system and method for transmitting a location signal indicative of the location of the vehicle to a first wireless device is provided. The system comprises a navigation module and a controller. The navigation module is positioned within the vehicle and is configured to transmit a location signal indicative of the physical location of the vehicle. The controller is configured to transmit the location signal as a radio frequency (RF) based signal to the at least one wireless device in response to detecting the occurrence of at least one predetermined vehicle event.

### BACKGROUND

1. Technical Field

One or more embodiments of the present invention generally relate to a system and method for storing location information about a vehicle on a wireless device.

2. Background Art

One such conventional car finder system generally includes a keyfob and a cell phone that are capable of communicating with one another via a Bluetooth™ protocol. The cell phone includes a proprietary software application and executes such an application to record and provide the location of the vehicle. The car finder operation generally includes an operator triggering the keyfob to transmit a lock command to lock the vehicle. The cell phone also receives the lock command from the keyfob via the Bluetooth™ protocol so that the cell phone records the location of the vehicle in response to the command.

While such a conventional car finder system is generally useful, it is possible that the vehicle operator may be a physically located away (e.g., 20 m to 150 m) from the vehicle while locking the vehicle with the keyfob. Such a condition may provide the situation whereby false locations are stored in the cell phone when the operator locks the vehicle with the keyfob while separated from the vehicle. In addition, accidental depression of the keyfob while located away from the vehicle (e.g., operator in workplace and vehicle in parking lot) causes the keyfob to transmit the lock command to the cell phone whereby the cell phone re-records or overwrites a previously valid stored location of the vehicle in response to the accidental depression.

Studies performed by at least one original equipment manufacturer (OEMs) indicate that a large percentage of vehicle operators lock their respective vehicles by use of trim switches located interior to the vehicle or with a keypad located exterior to the vehicle and not with the keyfob. Such locking operations performed by the operator generally prevents the cell phone from recording the location of the vehicle as no command is capable of being sent to the cell phone from the vehicle in such a case.

### SUMMARY

In at least one embodiment, a system for transmitting a location signal indicative of the location of the vehicle to a first wireless device is provided. The system comprises a navigation module and a controller. The navigation module is positioned within the vehicle and is configured to transmit a location signal indicative of the physical location of the vehicle. The controller is configured to transmit the location signal as a radio frequency (RF) based signal to the at least one wireless device in response to detecting the occurrence of at least one predetermined vehicle event.

### BRIEF DESCRIPTION OF THE DRAWINGS

FIG. 1 depicts a system for transmitting location signals indicative of the position of the vehicle; and

FIG. 2 depicts a method for transmitting location signals from the vehicle to the wireless device in accordance to one embodiment of the present invention.

### DETAILED DESCRIPTION

The embodiments of the present invention generally provide for, and not limited to, at least one controller in a vehicle that is capable of transmitting a location signal indicative of the location of the vehicle in response to one or more predetermined vehicle events being detected. Such predetermined vehicle events may include, but not limited to, locking the vehicle, parking the vehicle, and/or turning the engine off. At least one portable wireless device receives and stores the location signal. Such a location signal provides the location of the vehicle for a vehicle operator in the event the operator is unable to locate the vehicle while attempting to return to a parked vehicle. The operator may access and obtain the location of the vehicle from the portable wireless device(s).

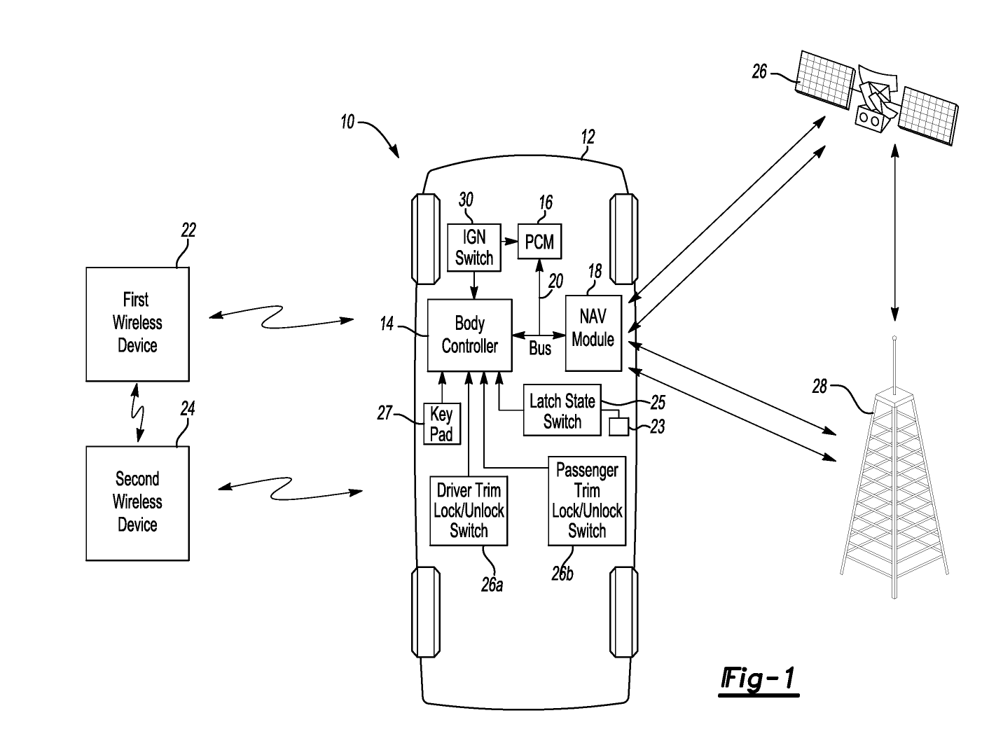

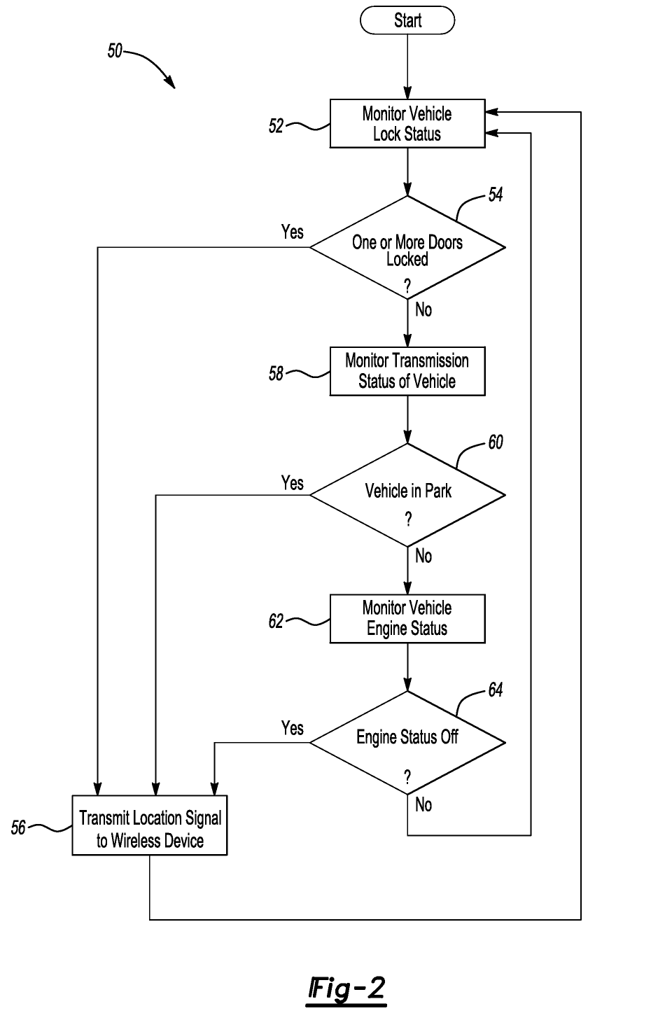

The embodiments of the present invention as set forth in FIGS. 1-2 generally illustrate and describe a plurality of controllers (or modules), or other such electrically based components. All references to the various controllers and electrically based components and the functionality provided for each, are not intended to be limited to encompassing only what is illustrated and described herein. While particular labels may be assigned to the various controllers and/or electrical components disclosed, such labels are not intended to limit the scope of operation for the controllers and/or the electrical components. The controllers (or modules) may be combined with each other and/or separated in any manner based on the particular type of electrical architecture that is desired or intended to be implemented in the vehicle. Further, it is generally understood that such controllers, modules, wireless devices and/or other such applicable electrical devices generally include hardware, software, and/or firmware for executing various operations of the present invention.

FIG. 1 depicts a system 10 for transmitting location signals indicative of the position of the vehicle 12. The system 10 generally includes a body controller 14, a powertrain control module (PCM) 16, and a navigation module 18. A communication bus 20 is operatively coupled between the body controller 14, the PCM 16, and the navigation module 18 to facilitate bi-directional communication therebetween. The communication bus 20 may be implemented as a High/Medium Speed Controller Area Network (CAN) bus, a Local Interconnect Network (LIN), or any such suitable data link communication bus generally situated to facilitate data transfer between the controllers (or modules) in the vehicle 12.

A first wireless device 22 is electrically coupled to the body controller 14. The first wireless device 22 includes a Bluetooth™ protocol stored therein so that the first wireless device 22 is capable of communicating with other such Bluetooth™ communication capable devices. For example, a second wireless device 24 may be situated to communicate with the first wireless device 22. Each of the first and the second wireless devices 22 and 24 are portable. The first wireless device 22 may be implemented as a keyfob for controlling one or more operations of the vehicle. The first wireless device 22 may transmit RF signals corresponding to, but not limited to, unlock/lock commands to the vehicle 12. The body controller 14 generally includes an antenna (not shown) and a receiver (not shown) for receiving and decoding the RF signals. The body controller 14 is configured to, among other things, unlock/lock doors of the vehicle 12 in response to the RF signals. The body controller 14 generally includes at least one transmitter (not shown) for transmitting RF signals back to the first wireless device 22 and/or the second wireless device 24.

The second wireless device 24 may be implemented as a cell phone, laptop, electronic organizer (e.g., Palm device), or global positioning satellite (GPS) device or other such device generally situated to communicate with the first wireless device 22. The first wireless device 22 may optionally include a display for providing visual information to the operator. It is generally recognized that the second wireless device 24 includes a display to visually communicate with the operator.

Driver and passenger lock/unlock switches 26a-26n are operatively coupled to the body controller 14 for controlling the body controller 14 to unlock/lock corresponding doors of the vehicle 12. The switches 26a-26n may be hardwired or RF coupled to the body controller 14 for controlling the body controller 14 to unlock/lock door(s). The switches 26a-26n may be positioned within the interior of the vehicle 12. A keypad 27 positioned on the exterior of the vehicle 12 may also unlock/lock the door(s) of the vehicle in response to predetermined alphanumerical characters being inputted thereto. Such a keypad operation is known in the art and will not be described further. At least one latch state switch 25 is operably coupled to the body controller 14. A latch assembly 23 including a latch (not shown) and a paddle (or solder) is coupled to the latch state switch 25 so that the latch state switch 25 communicates the lock status to the body controller 14 in response to the user manually locking a door of the vehicle via movement of the paddle or solder. The latch moves to the locked or unlocked state in response to the user moving the paddle.

An ignition switch 30 is operatively coupled to the body controller 14 and the PCM 16 for receiving at least one key to start/turn off an engine of the vehicle 12. The body controller 14 and/or the PCM 16 may generate and transmit an ignition status signal over the bus 20 to the navigation module 18 based on the position of the key in the ignition switch 30. The ignition status signal may indicate whether the key is in the “ON” or “OFF” position while within the switch 30, whether the switch 30 is moved to the “START” position to start the engine of the vehicle, and whether the switch 30 is in the “RUN” position. The ignition status signal generally corresponds to engine status (e.g., whether the engine is being started, in the RUN position or ON/OFF position).

In one example, the system 10 may employ a passive entry passive start (PEPS) implementation thereby obviating the need to implement the ignition switch 30 within the system. With the PEPS implementation, the body controller 14 may unlock/look the vehicle in response to the body controller 14 determining that the first wireless device 22 is a predetermined distance away from the vehicle 12. In such a case, the first wireless device 22 automatically (or passively) transmits encrypted RF signals (e.g., without user intervention) in order for the body controller 14 to decrypt (or decode) the RF signals and to determine if the first wireless device 22 is within the predetermined distance. It is to be noted that with the PEPS implementation, the first wireless device 22 may also generate RF signals which correspond to encoded lock/unlock commands in response to a user depressing lock switches or unlock switches. In this aspect, the first wireless device 22 operates as a keyfob. In addition, with the PEPS system, a key may not be needed to start the vehicle 12. Instead, the operator in this case may be required to depress the brake pedal switch or perform some predetermined operation prior to depressing a start/stop switch (not shown) to start the vehicle after the operator has entered into the vehicle. The start/stop switch may be coupled to the PCM 16. After performing the predetermined operation, the operator may depress the start/stop switch to start the vehicle. To turn the engine off, the operator may depress the start/stop switch to turn the engine off. The PCM 16 in the PEPS implementation may provide engine status (e.g., engine start or stop) over the bus 20 to body controller 14 and/or the navigation module 18 in response to the operator toggling the start/stop switch. As exhibited above, engine status may be obtained via the implementation of the ignition switch 30 or the implementation of the PEPS system.

The PCM 16 is configured to transmit vehicle transmission status signals (or transmission status signals) over the bus 20 to the body controller 14 and/or the navigation module 18. The transmission status signals may correspond to whether the vehicle is in the “PARK”, “NEUTRAL”, “REVERSE”, and “DRIVE” positions. The PCM 16 may be operatively coupled to an electronic transmission module (not shown) which generates the transmission status signal or include the electronic transmission module therein. Further, the PCM 16 (or other suitable controller) may also monitor parking brake status and transmit such status to the body controller 14. The body controller 14 may use parking brake status or an indicator that the vehicle is in the “PARK” position for the automatic or manual transmission.

The navigation module 18 is configured to determine the location of the vehicle and transmit location signals indicative of the location of the vehicle over the bus 20. Such location signals may include the vehicle's GPS coordinates and a pictorial map of the location in which the vehicle is positioned. It is generally contemplated that the body controller 14 may transmit the vehicle's GPS coordinates and the pictorial representation of the vehicle's position to the first and/or second wireless device 22, 24. In such an example, the navigation module 18 may capture a screen image of the pictorial map and transmit such data to the body controller 14. The body controller 14 transmits the screen image of the pictorial map to the first and/or second wireless devices 22, 24. The wireless devices 22, 24 may also utilize existing implementations for receiving pictorial information as currently offered by various cell phone carriers.

At least one satellite 26 and/or at least one ground station 28 communicate with the navigation module 18 to establish the location of the vehicle 12. In one example, the satellite 26 may be implemented as a NavStar GPS satellite. The navigation module 18 is capable of establishing the vehicle's position and velocity relative to the earth's surface by processing data received by the satellites 26 and/or the ground station 28. As the vehicle 12 moves latitudinal and/or longitudinally across the earth's surface, the navigation module 18 is capable of presenting the position of the vehicle 12 with reference coordinates which correspond to, among other things, the latitude and longitude on the earth's surface. It is generally known that the implementation of a navigation module 18 in a vehicle is capable of providing the position of the vehicle relative to the earth's surface. Further, the navigation module 18 may also establish the elevation of the vehicle 12 by processing data received by the satellites 26 and/or the ground station 28. In such an example, such information may be transmitted from the navigation module 18 to the body controller 14 and to the first and/or second wireless devices 22, 24 for display thereon in the event elevational information may be requested by the user.

The body controller 14 may transmit the location signal as an RF based signal to the first and/or the second wireless devices 22, 24 based on various predetermined vehicle events that are detected to have occurred. Alternatively, the first wireless device 22 may receive the location signal and transmit such data to the second wireless device 24. For example, assuming that that the first wireless device 22 is a keyfob that is capable of communicating via the Bluetooth™ protocol, the first wireless device 22 may transmit the location of the vehicle to any such second wireless device 24 that is Bluetooth™ capable (e.g., cell phone, laptop, portable GPS device, PALM, etc.). Such a condition may prove useful in the event the second wireless device 24 includes greater display capability than that of the keyfob. Keyfobs may or may not include displays for visually communicating with vehicle operators. In the event the keyfob does not include a display, the keyfob may transmit the location of the vehicle along with the pictorial map of the location to the second wireless device 24. The keyfob may include software therein for enabling the transmission of the pictorial map of the location to the second wireless device 24. The software included within the keyfob may be similar to what is used within the cellular phone industry for sending pictures from phone to phone. The second wireless device 24 displays the location of the vehicle along with the pictorial map for the operator when the operator intends to find the location of the vehicle upon returning to the parked vehicle.

In the event the second wireless device 24 is a handheld GPS device, the GPS device may use the location coordinates in the keyfob to plot an A-B map. The A-B map includes a start position (or A-position) corresponding to the user's current location and a final position (or B-position) corresponding to the vehicle's location. The user may enter the user's current location into the first or the second wireless device 22, 24 to obtain the start position.

FIG. 2 depicts a method 50 for transmitting the location signal(s) from the vehicle 12 to the first and/or second wireless devices 22, 24 in accordance to one embodiment of the present invention. The body controller 14 (or other suitable controller) includes logic (software or hardware or combination thereof) for executing operations of the method 50. The operations as described below may be performed sequentially or non-sequentially. Further, the operations are capable of being performed simultaneously or serially with respect to one another. The particular order and execution times of the operations set forth below may vary based on the desired criteria of a particular implementation.

In operation 52, the body controller 14 monitors lock status of the vehicle. In one example, the body controller 14 monitors inputs received by the first wireless device 22, the lock/unlock switches 26a-26n, the latch state switch 25 and the keypad 27 (or other suitable device generally situated to control the locking of the vehicle) to determine if the operator has locked one or more doors of the vehicle 12.

In operation 54, if the body controller 14 determines that the lock door command has been issued from the first wireless device 22, the switches 26a-26n, and/or the keypad 27, the method 50 moves to operation 56. The indication that one or more of the vehicle doors are being locked may correspond to the situation in which the operator intends to park the vehicle 12. If the body controller 14 does not receive a lock door command, the method 50 moves to operation 58.

In operation 58, the body controller 14 monitors transmission status of the vehicle 12. For example, the body controller 14 monitors the transmission status signals transmitted over the bus 20 by the PCM 16 to determine if the vehicle is in “parked” state. In the event the vehicle 12 includes a manual transmission, the body controller 14 may optionally monitor whether the parking brake is enabled to make a determination that the vehicle is in the parked state. Parking brake status may also be monitored for automatic transmission types to make a determination as to whether the vehicle is in a parked state.

In operation 60, if the body controller 14 determines that the vehicle 12 is in the parked state, the method 50 moves to operation 56. If the body controller 14 determines that the transmission status signal does not correspond to the vehicle being in the parked state, the method 50 moves to operation 62.

In operation 62, the body controller 14 monitors engine status of the vehicle 12. For example, in one implementation, the body controller 14 monitors signals from the ignition switch 30 to determine engine status of the vehicle 12 (e.g., OFF, RUN, or START). In the PEPS implementation, the body controller 14 monitors the engine status signal received on the bus 20 from the PCM 16 to determine engine status of the vehicle 12.

In operation 64, if the body controller 14 determines that the engine of the vehicle 12 is in the “OFF” state in response to signals transmitted from the ignition switch 30 or the engine status signal from the PCM 16, the method 50 moves to operation 56. If the body controller 14 determines that the engine of the vehicle 12 is in any other state other than the “OFF” state in response to signals transmitted from the ignition switch 30 or the engine status signal from the PCM 16, the method 50 moves back to operation 52.

In operation 56, the body controller 14 transmits the location signal as an RF signal (as last received or updated by the navigation module 18) to the first wireless device 22 and or the second wireless device 24 for later retrieval of the location of the vehicle 12 so that the operator can locate the vehicle 12. In another example, the body controller 14 may request that the navigation module 18 provide the last known location of the vehicle in response to one or more of the conditions as noted in operations 54, 60, 64 being true prior to transmitting the location signal to the first wireless device 22. Such a condition may ensure that the location signal includes current information with respect to the location of the vehicle 12. The first wireless device 22 may optionally transmit the location of vehicle to another Bluetooth™ capable device such as the second wireless device 24.

While embodiments of the present invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A system for transmitting a location signal indicative of the location of the vehicle to a first wireless device, the system comprising:
a navigation module positioned within the vehicle and being configured to transmit a location signal indicative of the physical location of the vehicle; and
a controller configured to transmit the location signal as a radio frequency (RF) based signal to the at least one wireless device in response to detecting the occurrence of at least one predetermined vehicle event.

2. The system of claim 1 further comprising at least one interior lock/unlock switch positioned with the vehicle, wherein the at least one predetermined vehicle event comprises locking the vehicle with the at least one interior lock/unlock switch.

3. The system of claim 1 further comprising at least one keypad coupled to an exterior portion of the vehicle, wherein the at least one predetermined vehicle event comprises locking the vehicle with the at least one keypad.

4. The system of claim 1 wherein the at least one predetermined vehicle event comprises disabling an operation of an engine of the vehicle.

5. The system of claim 1 wherein the at least one predetermined vehicle event comprises placing the vehicle in a parked condition.

6. The system of claim 1 wherein the first wireless device is configured to transmit the location signal to a second wireless device via a Bluetooth protocol.

7. The system of claim 1 wherein the first wireless device is a keyfob.

8. A method for transmitting a location signal indicative of the location of the vehicle to a first wireless device, the method comprising:
generating a location signal indicative of the physical location of a vehicle;
detecting the occurrence of at least one predetermined vehicle event; and
transmitting the location signal as a radio frequency (RF) based signal to the first wireless device in response to detecting the occurrence of the least one predetermined vehicle event.

9. The method of claim 8 wherein detecting the occurrence of the at least one predetermined vehicle event further comprises detecting the occurrence of a vehicle locking event.

10. The method of claim 9 wherein detecting the occurrence of the vehicle locking event further comprises detecting the occurrence of a locking event caused by at least one of the actuation of a keypad positioned exterior to the vehicle, the actuation of at least one interior lock/unlock switch, and the actuation of a manual lock.

11. The method of claim 8 wherein detecting the occurrence of the at least one predetermined vehicle event further comprises detecting the occurrence of disabling engine operation of the vehicle.

12. The method of claim 8 wherein detecting the occurrence of the at least one predetermined vehicle event further comprises detecting the occurrence of a vehicle parking event by performing at least one of monitoring transmission status for an automatic-based transmission vehicle and parking brake status for a manual-based transmission vehicle.

13. The method of claim 8 further comprising transmitting the location signal from the first wireless device to a second wireless device via a Bluetooth communication protocol.

14. A system for transmitting a location signal indicative of the location of the vehicle to a first wireless device, the vehicle includes a navigation module positioned within the vehicle and being configured to transmit a location signal indicative of the physical location of the vehicle, the system comprising:
a controller configured to transmit the location signal as a radio frequency (RF) based signal to the first wireless device in response to at least one of detecting the occurrence of an engine disable event, detecting the occurrence of a vehicle parking event, and detecting the occurrence of a vehicle locking event caused by at least one of the actuation of at least one interior lock/unlock switch, the actuation of at least one keypad positioned exterior to the vehicle, and the actuation of a manual lock.

15. The system of claim 14 wherein the first wireless device is configured to transmit the location signal to a second wireless device via a Bluetooth protocol.

16. The system of claim 14 wherein the first wireless device is a keyfob.

17. The system of claim 15 wherein the second wireless device comprises at least one of a cell phone, a hand-held global positioning satellite device, and a laptop.
